(19) United States
(12) Patent Application Publication
(10) Pub. No.: US 2005/0101349 A1
(43) Pub. Date: May 12, 2005

(54) Open modem - RFU interface

(75) Inventors: Jussi Pihlajamaa, Espoo (FI); Kalle Jokio, Helsinki (FI); Pekka Wainio, Kauniainen (FI); Olli Harju, Espoo (FI); Hannu Haapajarvi, Vantaa (FI); Antti Hirvela, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/821,868

(22) Filed: Apr. 12, 2004

(30) Foreign Application Priority Data
Nov. 10, 2003 (EP) 03 025 822.2

(51) Int. Cl. H04B 1/713

(52) U.S. Cl. 455/557

(57) ABSTRACT

A method of running a radio equipment, comprising providing a radio equipment having a structure of physically separate modules of a baseband modem and a radio frequency unit including radio frequency control means and radio frequency parts means; and providing a digital interface for the connection of the baseband modem module and the radio frequency unit module with each other within the radio equipment.

### BACKGROUND OF THE INVENTION

The present invention relates to radio link systems in the area of wireless communications, and particularly, the present invention relates to a radio equipment system having a modular structure, a method of running a radio equipment, and a digital interface for connecting a baseband modem module with a radio frequency unit module within a radio equipment.

### RELATED BACKGROUND ART

The radio communication system topologies considered here are “point to point” (PtP) and “point to multipoint” (PMP) which are shown in FIG. 1.

In point to point topology, two radio devices in different locations form a radio link through a line of sight (LOS) connection, as is shown in FIG. 1. A radio link can operate with different modulation methods, capacities and frequencies. A usual frequency range for a radio equipment is 2-66 GHz. The traffic mode in point to point links is continuous mode traffic. Typically, point to point radio links are used in a mobile communication network to form a connection between base transceiver stations (BTS), between BTS and base station controller (BSC), and between BSC and mobile switching center (MSC).

In a point to multipoint topology, the radio communication network includes an access point (AP) and several access terminals (AT), as is presented in FIG. 1.

A point to multipoint network offers broadband wireless access (BWA) through line of sight connections between access points and access terminals. An important feature of a point to multipoint network is that it is able to adapt to different link conditions, as for example changing weather conditions, and capacity demands through adaptive modulation and coding functions. The traffic mode in a point to multipoint system is packet mode traffic. A point to multipoint system can be used e.g. for corporate communications and small office/home office broadband connections, and it offers one solution to handle the growing amount of the Internet traffic.

The frequency bands for radio communication are usually licensed, and the availability and prices of frequency bands vary in different countries. Effective utilization of the available bandwidth is essential for network operators. Also, the equipment manufacturer has to support multiple frequency bands.

In the following, the basic structure of a radio equipment is presented, as it is e.g. implemented by the present applicant/assignee.

FIG. 2 shows the general structure of a radio device as offered by the applicant/assignee. The system comprises an indoor unit, an outdoor unit and a coaxial cable that connects these. The outdoor unit includes a modem and radio frequency parts. In the following, the description is focused on the outdoor unit, because this is the area affected by the present invention.

An overview of the outdoor unit structure is presented in FIG. 3. The main parts of the outdoor unit are the antenna, radio frequency parts, a modem and an interface to the indoor unit. Digital to analog conversion is performed to the transmitted signal between the modem and the radio frequency parts. Accordingly, analog to digital conversion is performed to the received signal.

Basically, the modem part includes the functions of forward error correction (FEC) coding and decoding; symbol mapping and demapping such as the mapping of symbols to constellation points where, after symbol mapping, the signal has I- and Q-branches; pulse shaping filtering (matched filtering); transmitter (TX) and receiver (RX) correction loops including correction loops which implement digital correction algorithms to correct imbalance between I- and Q-branches caused by analog IQ-mixer and AD-converter, a quadratic error correction, a balance error correction, a bias error correction, and a gain error correction; receiver timing recovery where the received signal symbol timing is recovered; and carrier recovery.

Digital correction loops are used to ease the requirements for radio frequency parts in the system. The receiver timing and carrier recovery loops can be implemented as a non-data-aided (NDA) or a data-aided (DA) type. The performance of data-aided algorithms is better than non-data-aided algorithms, but they need some knowledge of the received data to be able to operate. Usually, both kinds of algorithms are implemented in a modem.

All the above presented modem functions plus some possible other functions have conventionally been implemented in a single modem block. Typically, the implementation has been a digital application specific integrated circuit (ASIC). A specific modem solution and radio frequency part has been developed for each new system, and that is why the baseband (BB) modem and radio frequency part design of a system have been highly dependent of each other. The testing of radio frequency parts in product development phase was not possible until also the baseband modem design was ready, and vice versa.

The equipment is optimized to a certain application. The baseband modem and RF parts are tightly coupled, and need to be developed together. For example, digital correction loops are developed for a certain radio frequency solution. Changes in the system are not usually easy to make, require a high design effort and may be quite time consuming.

In case changes are made in some parts of the system, the implementation of the whole system may have to be re-considered. Especially the high amount of re-design is time consuming and increases product development cost.

In every new product variant, the modem and radio frequency parts need to be developed as one whole system. They cannot be easily independently tested, because the complete modem design is needed to test radio frequency parts. Possibilities to use some third party components (for example modem chips) in system design or testing are usually very limited due to the closed nature of the system.

### SUMMARY OF THE INVENTION

Therefore, it is an object of the present invention to overcome the shortcomings of the above prior art.

The present invention is a radio equipment system having a modular structure, the system comprising a baseband modem, a digital interface, and a radio frequency unit including radio frequency control means and radio frequency parts means, wherein the baseband modem and the radio frequency unit respectively form physically separate modules which are connected with each other by the digital interface.

According to a preferred modification of the present invention, the module forming the baseband modem may include a functionality of forward error correction coding and decoding as well as a functionality of symbol mapping and demapping, while the radio frequency control means within the module forming the radio frequency unit may include respective control loops having a functionality of pulse shape filtering, a functionality of transmitter and receiver correction loops, a functionality of receiver timing recovery and a functionality of carrier recovery.

Preferably, the invention is further modified by the functionality of transmitter and receiver correction loops comprising a quadratic error correction functionality, a balance error correction functionality, a bias error correction functionality, and a gain error correction functionality.

Still further, the control loops may be independent of the modulation or traffic type.

The invention is also a method of running a radio equipment, comprising providing a radio equipment having a structure of physically separate modules of a baseband modem and a radio frequency unit including radio frequency control means and radio frequency parts means; and providing a digital interface for the connection of the baseband modem module and the radio frequency unit module with each other within the radio equipment.

As a particularly preferred modification thereof, the interface may perform the driving of sending, from the baseband modem module to the radio frequency unit module, transmitter data including in-phase component signals and quadratic phase component signals; sending, from the baseband modem module to the radio frequency unit module, transmitter clock signals; sending, from the baseband modem module to the radio frequency unit module, control signals providing support for type-specific functionalities; sending, from the radio frequency unit module to the baseband modem module, receiver clock signals; sending, from the radio frequency unit module to the baseband modem module, receiver data including in-phase component signals and quadratic phase component signals; and exchanging, between the radio frequency unit module and the baseband modem module, microprocessor signals.

According to this modification of the invention, all signals may be digital and a clock rate may be a system symbol clock rate, except for the case that a function in the modem requires two samples per symbol where a double symbol rate frequency is supported.

Moreover, in the method according to the present invention, the module forming the baseband modem may perform the functions of forward error correction coding and decoding as well as of symbol mapping and demapping, while the radio frequency control means within the module forming the radio frequency unit includes respective control loops which may perform pulse shape filtering, transmitter and receiver correction, receiver timing recovery and carrier recovery.

In this case, the transmitter and receiver correction may comprise a quadratic error correction, a balance error correction, a bias error correction, and a gain error correction, and the control loops may perform independently of the modulation or traffic type.

Still further, the present invention is a digital interface for connecting a baseband modem module with a radio frequency unit module within a radio equipment, wherein the baseband modem module and the radio frequency unit module are physically separated, and wherein the interface is adapted to perform the signal exchange between the modules.

As an option, the signals may be exchanged serially or in parallel in the interface.

In a preferred modification, the interface further comprises means for sending, from the baseband modem module to the radio frequency unit module, transmitter data including in-phase component signals and quadratic phase component signals; means for sending, from the baseband modem module to the radio frequency unit module, transmitter clock signals; means for sending, from the baseband modem module to the radio frequency unit module, control signals providing support for type-specific functionalities; means for sending, from the radio frequency unit module to the baseband modem module, receiver clock signals; means for sending, from the radio frequency unit module to the baseband modem module, receiver data including in-phase component signals and quadratic phase component signals; and means for exchanging, between the radio frequency unit module and the baseband modem module, microprocessor signals.

According to the present invention, a new interface and modular design principle is introduced to radio system design. Thus, separate designing, testing and manufacturing of radio frequency and baseband parts in the radio equipment is facilitated and gives flexibility to the modem and radio frequency device design. It makes the radio system more capable to adapt rapid changes in the system specifications, for example in the modulation method or the traffic mode. Modem and radio frequency platforms can be developed, manufactured and tested separately with independent releases.

Further, the radio frequency device integration can be started earlier as according to the prior art and the risk for the whole system is lower because of a reduced design complexity for one entity. The amount of re-design decreases, because the interface supports multiple modulations, applications and traffic modes. Cost savings are achieved through simpler logistics and higher volumes in radio production.

The interface is open to third party component producers, which provides more flexibility in the system design and testing. The open interface and modular design also provides the possibility to find new markets by providing for example radio frequency modules to customers instead of the whole system.

According to the present invention, a new kind of functional split is introduced in the radio modem functions by using a digital interface. Therefore, the term “open modem—RF unit interface” is used here. The interface enables the possibility of a new kind of modular design of radio systems.

According to the above, some digital baseband modem functions can be separated from the known baseband modem to an own digital radio frequency control block by using a digital interface. The radio frequency control block and the radio frequency parts form together the radio frequency unit (RFU) module.

The open modem—RFU interface provides a generic interface between the baseband modem and the radio frequency unit. The interface makes the radio frequency unit module independent of the modulation or application and traffic type. It also enables to develop and manufacture modem and radio frequency unit modules independently, and therefore reduces the need to redesign the modem in case the radio frequency is changed, or vice versa. The new interface provides more flexibility to the baseband modem and radio frequency design when compared to the known solutions in radio devices.

These and other features, modifications, and advantages will become more fully apparent from the following detailed description of the preferred embodiments of the present invention which is to be taken in conjunction with the accompanying drawings.

### BRIEF DESCRIPTION OF THE DRAWINGS

FIG. 1 shows point to point and point to multipoint network topologies;

FIG. 2 shows a radio equipment according to the prior art;

FIG. 3 shows an outdoor unit structure of the radio equipment according to FIG. 3;

FIG. 4 shows the open modem—RFU interface solution according to the present invention; and

FIG. 5 shows an implementation of the open modem—RFU interface as a preferred embodiment of the present invention.

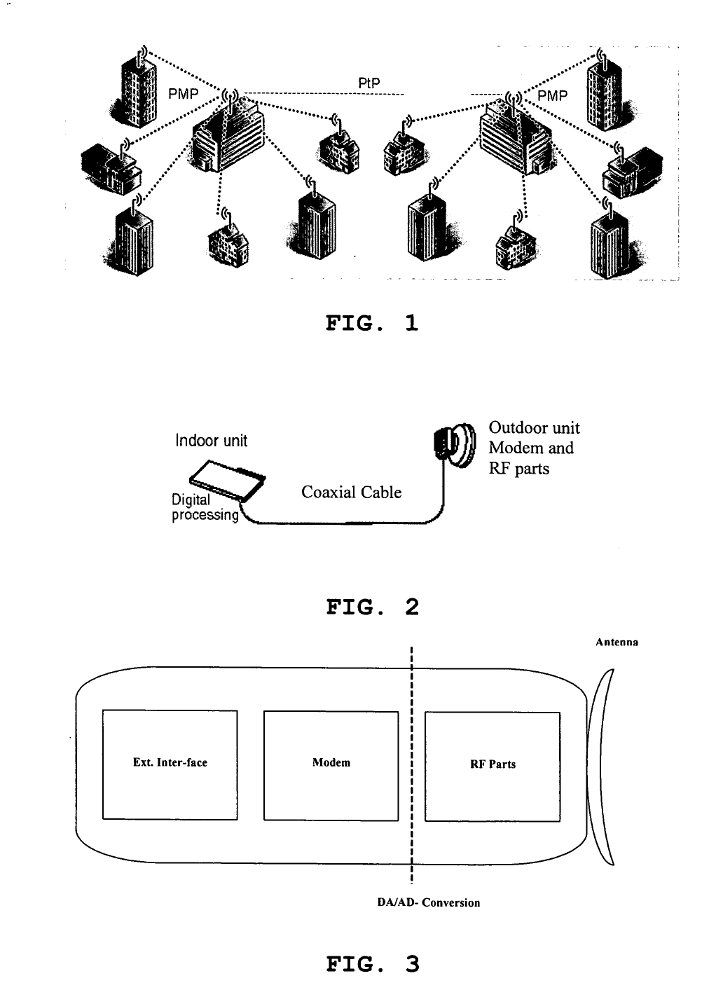

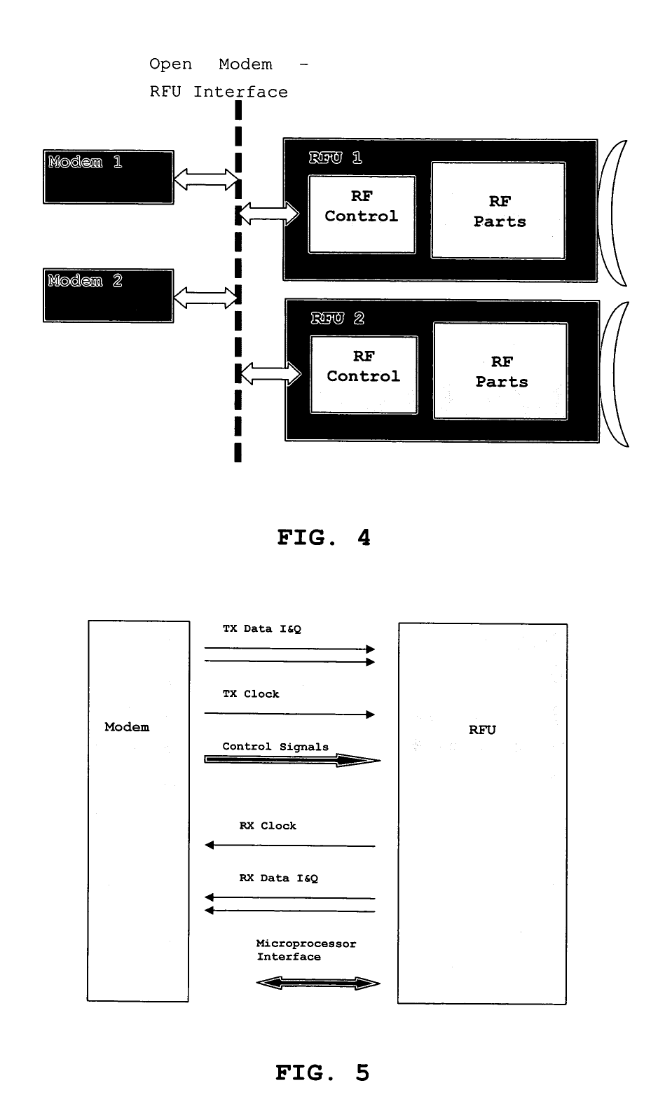

### DETAILED DESCRIPTION OF THE PREFERRED EMBODIMENTS

In the present invention, some of the digital modem functions, which were previously implemented in the baseband (BB) modem, have been moved to the radio frequency control block in the radio frequency unit module. With the new interface, the functional split based on the modem function presentation given above between the baseband modem and radio frequency control block could be for example as presented in the following. Also other functional split alternatives are possible and covered by the present invention so that the following description is not intended to limit the present invention to the depicted embodiments.

Preferred Embodiment of the System

In the following, a preferred embodiment of the system according to the present invention is described. Accordingly, a new functional split is chosen as follows:

The baseband modem functionality comprises the functions of forward error correction (FEC) coding and decoding and symbol mapping and demapping.

On the other hand, the radio frequency control functionality comprises the functions of pulse shape filtering (matched filtering); transmitter (TX) and receiver (RX) correction loops for e.g. quadratic error correction, balance error correction, bias error correction, and gain error correction; receiver timing recovery; and carrier recovery.

All the above control loops are independent of the modulation or traffic type such as continuous data or packet mode data.

The interface is meant to be open to third party component and unit suppliers. The interface makes it possible to use standard components and more vendors. With such a flexibility, higher volumes can be achieved which declines prices and gives more choices for the final product.

The testing of the radio frequency unit module is possible by using a general test equipment or simple third party modems. For example, production testing is easier. There is no need to have the system specific modem part ready to be able to test radio frequency parts as in earlier solutions. Transmitter and receiver data signals in the open modem interface are comparable, because the radio frequency control includes all the necessary correction loops.

Thus, important advantages of the system according to the present invention are an increased flexibility to modem and radio frequency design and manufacturing.

Specifically, the open modem—RFU interface makes modem and radio frequency parts of the system independent of each other in product development, testing and manufacturing. Both modem and radio frequency platforms can be developed separately as standalone units with independent releases. Radio frequency integration can be started before the actual modem part is ready, and vice versa. Critical radio frequency specifications can be verified earlier in the product (release) development cycle than in traditional designs.

Furthermore, commercial modem chips or field programmable gate arrays (FPGA) can be used in radio frequency integration instead of the modem application specific integrated circuit (ASIC).

The testing and calibration of standalone radio frequency parts can be automated and the amount of functional testing in production can be reduced. This will lead to higher test coverage and lower manufacturing costs than with traditional radio architectures.

A further important advantage of the system according to the present invention is the modular design structure of the system.

In detail, the modular design structure provides possibilities for horizontal business. In addition to the whole system, also the radio modules can be sold to customers, which increases business volumes for modules and/or components.

The architecture underlying the present invention enables a minimization of the number of product variants and a maximization of component volumes for the critical components. Therefore, the total lifetime product cost can be decreased. Due to a common structure and reuse of architecture modules and components, the development of product variants and features is easier and faster. Essential savings in research and development costs and investments can be achieved.

In addition, there is an advantage of a reduced design complexity for one entity. That is, the open modem —RFU interface introduces smaller design entities in the system. Smaller entities are less complex, faster to design and test, and therefore include a lower risk level.

Preferred Embodiment of the Interface

The principle of a possible implementation of the open modem—RFU interface is presented in FIG. 5. The interface includes transmitter (TX) and receiver (RX) in-phase (I-) and quadratic phase (Q-) data signals, transmitter and receiver clock signals and some necessary control signals, for example for packet mode traffic support. Also a serial mode microprocessor interface is included. The modem and radio frequency unit (RFU) are connected together with a connector through which the interface signals are driven.

All the signals in the interface are digital, and the clock rate is the system symbol rate. However, in the receiver direction, a double symbol rate frequency has to be supported in case that some functions in modem require two samples per symbol.

Crucial items for the interface implementation are a low clock rate and a low pin count. Hence, the implementation is aimed to be as simple as possible.

To guarantee low pin count, a serializing of the interface signals can be considered. Serializing also provides flexibility to the distance between the baseband modem and the radio frequency unit. However, the present invention is not limited to the use of a serial interface and a parallel interface can be used as well.

Accordingly, the interface according to the present invention provides the advantage of supporting multiple modulations, applications and traffic modes.

Specifically, extensive support for different system specifications reduces the amount of re-design of the system. Therefore, changes in the specifications are easy and fast to implement to an existing system. For example, it is possible to use the same radio frequency unit module with different modems. The development of product variants and features is easier and faster.

Further, another important advantage of the interface according to the present invention is that the interface is open (industry standard) to third party component producers.

Hence, the open modem—RFU interface enables that component sourcing is easier and cheaper due to the increased amount of vendors. It is also possible to use commercial modem chips in product development and testing. The cooperation with different component vendors can be extended. Open interfaces enable also highly networked (partnered) product creation.

The above description includes a method of running a radio equipment, comprising providing a radio equipment having a structure of physically separate modules of a baseband modem and a radio frequency unit including radio frequency control means and radio frequency parts means; and providing a digital interface for the connection of the baseband modem module and the radio frequency unit module with each other within the radio equipment.

While it is described above what is presently considered to be the preferred embodiments of the present invention, it is to be understood that the same is presented by way of example only, and that various modifications may be made without departing from the spirit and scope of the present invention as defined in the appended claims.

1. A radio equipment system having a modular structure, the system comprising:
a baseband modem;
a digital interface; and
a radio frequency unit including radio frequency control means and radio frequency parts means, wherein the baseband modem and the radio frequency unit respectively form physically separate modules which are connected with each other by the digital interface.

2. The system according to claim 1, wherein the module forming the baseband modem comprises:
correction means for performing forward error correction coding and decoding; and
symbol mapping means for symbol mapping and demapping.

3. The system according to claim 1, wherein the radio frequency control means comprises respective control loops for pulse shape filtering, transmitter and receiver correction loops, timing recovery means for performing receiver timing recovery, and carrier recovery means for performing carrier timing recovery.

4. The system according to claim 3, wherein the transmitter and receiver correction loops comprise quadratic error correction means for performing quadratic error correction, balance error correction means for performing balance error correction, bias error correction means for performing bias error correction, and a gain error correction means for performing bias error correction.

5. The system according to claim 3, wherein the control loops are independent of the modulation or traffic type.

6. A method of running a radio equipment, said method comprising:
providing a radio equipment comprising physically separate modules of a baseband modem and a radio frequency unit including radio frequency control means and radio frequency parts means; and
providing a digital interface for connection of the baseband modem module and the radio frequency unit module with each other within the radio equipment.

7. The method according to claim 6, further comprising:
sending, from the baseband modem module to the radio frequency unit module, transmitter data including in-phase component signals and quadratic phase component signals;
sending, from the baseband modem module to the radio frequency unit module, transmitter clock signals;
sending, from the baseband modem module to the radio frequency unit module, control signals providing support for type-specific functionalities;
sending, from the radio frequency unit module to the baseband modem module, receiver clock signals;
sending, from the radio frequency unit module to the baseband modem module, receiver data including in-phase component signals and quadratic phase component signals; and
exchanging, between the radio frequency unit module and the baseband modem module, microprocessor signals;
wherein said sending steps and said exchanging step are driven by the digital interface.

8. The method according to claim 7, said method further comprising providing all signals as digital signals, and wherein a clock rate is provided as a system symbol clock rate, except for a case that a function in the modem utilizes two samples per symbol where a double symbol rate frequency is supported.

9. The method according to claim 6, further comprising the steps of:
forward error correction coding and decoding;
symbol mapping and demapping; and
implementing the forward error correction coding and decoding and symbol mapping and demapping steps in the baseband modem.

10. The method system according to claim 6, wherein the radio frequency control means within the module forming the radio frequency unit includes respective control loops performing pulse shape filtering, transmitter and receiver correction, receiver timing recovery and carrier recovery.

11. The method according to claim 10, wherein the transmitter and receiver correction comprises a quadratic error correction, a balance error correction, a bias error correction, and a gain error correction.

12. The method according to claim 10, wherein the control loops perform independently of the modulation or traffic type.

13. A digital interface for connecting a baseband modem module with a radio frequency unit module within a radio equipment, wherein the baseband modem module and the radio frequency unit module are physically separated, and wherein the interface is configured to perform the signal exchange between the modules.

14. The interface according to claim 13, wherein the signals are exchanged serially.

15. The interface according to claim 13, wherein the signals are exchanged in parallel.

16. The interface according to claim 13, further comprising:
first sending means for sending, from the baseband modem module to the radio frequency unit module, transmitter data including in-phase component signals and quadratic phase component signals;
second sending means for sending, from the baseband modem module to the radio frequency unit module, transmitter clock signals;
third sending means for sending, from the baseband modem module to the radio frequency unit module, control signals providing support for type-specific functionalities;
fourth sending means for sending, from the radio frequency unit module to the baseband modem module, receiver clock signals;
fifth sending means for sending, from the radio frequency unit module to the baseband modem module, receiver data including in-phase component signals and quadratic phase component signals; and
exchanging means for exchanging, between the radio frequency unit module and the baseband modem module, microprocessor signals.
